(19) United States
(12) Patent Application Publication
(10) Pub. No.: US 2009/0055856 A1
(43) Pub. Date: Feb. 26, 2009

(54) System and Method for Managing Media Content

(75) Inventor: Michael R. Christian, Carmel, IN (US)

Correspondence Address: FLETCHER YODER P.C., 7915 FM 1960 RD. WEST, SUITE 330, HOUSTON, TX, 77070, US

(73) Assignee: Shenzhen TCL New Technology LTD, Guangdong (CN)

(21) Appl. No.: 11/843,120

(22) Filed: Aug. 22, 2007

(51) Int. Cl. H04N 7/16

(52) U.S. Cl. 725/28

(57) ABSTRACT

There is provided a system and method for configuring a media management device. More specifically, in one exemplary embodiment, there is provided a method (300) comprising initiating a content blocking procedure based on activation of a content control mechanism, determining (306) at least one characteristic of content being provided at the time the content control mechanism was activated, and defining (326) a blocking configuration to block the content being provided at the time the content control mechanism was activated based on the at least one characteristic of the content.

### FIELD OF THE INVENTION

The present invention relates generally to managing the content of programming provided through an electronic media device, and more particularly to configuring a media management device.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

A media management device may be utilized to block certain programs from being provided through a particular media device. For example, a V-Chip may be considered as a type of a media management device. Specifically, the V-Chip may be defined as an electronic chip that cooperates with an electronic media device (e.g., a television, a VCR or a cable box) to block certain types of programming that are designated as undesirable by a user. For example, the V-Chip may allow parents to block television programming that they do not want their children to watch due to violent or sexual content.

Many television programs have been assigned a rating indicator based on content in accordance with broadcasting industry standards. For example, in the United States, the Federal Communications Commission (FCC) has adopted a rating system with the following labels and content indicators:

TV-Y—All Children

TV-Y7—Directed to Older Children

TV-G—General Audience

TV-PG—Parental Guidance Suggested

TV-14—Parents Strongly Cautioned

TV-MA—Mature Audience Only

See http://www.fcc.gov/vchip/

A user may utilize a V-Chip to block programming of a certain type by configuring blocking criteria of the V-Chip. For example, the FCC ratings set forth above may be utilized as criteria for blocking a particular program. However, many consumers do not utilize the V-Chip content blocking system because they are unaware of its existence and/or because the V-Chip blocking system utilizes a matrix-based interface that is often considered confusing.

### BRIEF DESCRIPTION OF THE DRAWINGS

Advantages of the invention may become apparent upon reading the following detailed description and upon reference to the drawings in which:

FIG. 1 is a block diagram of an electronic device in accordance with one embodiment of the present invention;

FIG. 2 is a block diagram representing a process in accordance with one exemplary embodiment of the present invention;

FIG. 3 is a block diagram representing a process in accordance with one exemplary embodiment of the present invention; and

FIG. 4 is a block diagram representing a process in accordance with one exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

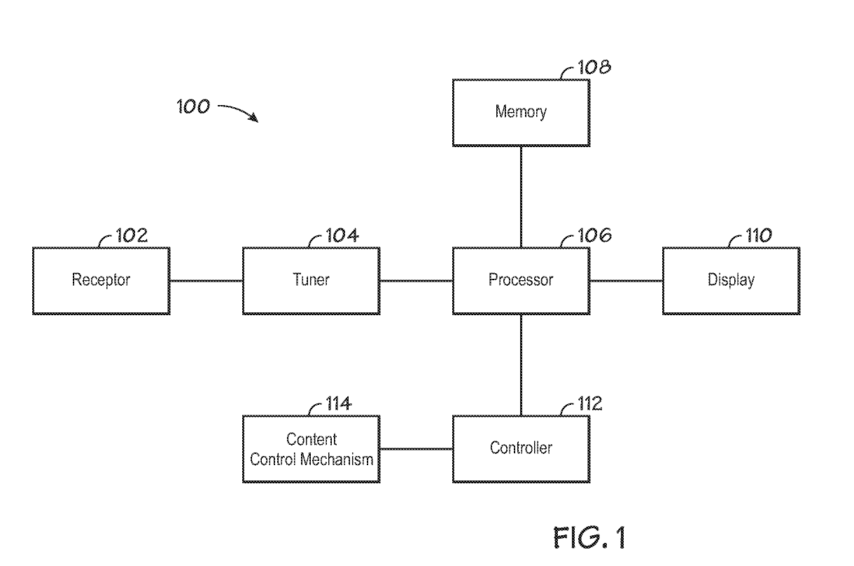

FIG. 1 is a block diagram of an electronic device in accordance with an exemplary embodiment of the present invention. The electronic device (e.g., a television) is generally indicated by reference numeral 100. The electronic device 100 comprises a receptor 102 (e.g., a cable inlet or an antenna), a receiver or tuner 104, a processor 106, a memory 108, a display 110, and a controller 112. The controller 112 (e.g., a remote control or buttons on the electronic device 100) may include a content control mechanism 114, such as a parental control button, that facilitates activation of features for blocking undesirable programming from being presented by the electronic device 100.

The memory 108 is a tangible, machine-readable medium that may be adapted to hold machine-readable computer code that causes the processor 106 to perform an exemplary method in accordance with the present invention. For example, in accordance with exemplary embodiments of the invention, the memory 108 may store computer 10 code that causes the processor 106 to prompt a user regarding blocking or unblocking undesirable channels based on input received from the content control mechanism 114 (e.g., parental control button). Further, the memory 108 may store computer code that causes the processor to add and/or remove channels or programs with certain content from a scan list based on input from a user. As discussed in further detail below, a user may define a blocking configuration that is stored in the memory 108 and that blocks certain content based on user selections and ratings.

The controller 112 may be configured such that the content control mechanism 114 is the only mechanism on the controller 112 that facilitates configuration of content blocking. However, in some embodiments, the controller 112 may include a number of buttons that directly or indirectly facilitate configuration of content blocking. The electronic device 100 may be configured such that pressing the content control mechanism 114 automatically adds certain characteristics (e.g., the rating information) from the content that is currently being decoded by the tuner 104 to a blocking configuration for the tuner 104. By employing the content control mechanism 114 in accordance with exemplary embodiments of the invention, the user can easily make choices about which content to block based on what the user views or hears on the program being observed.

In response to activation of the content control mechanism 114, the electronic device 100 may be configured to present a series of queries, which the user may answer using the controller 112. For example, a user may navigate between and select answers to the queries using buttons on a remote control. In one embodiment, the queries may be answered using only the content control mechanism 114. For example, the user could indicate a first of two selections by depressing a parental control button once or indicate a second of the two selections by pressing the parental control button twice in quick succession. The queries may be directed to confirming that the user understands the blocking choices being made and to facilitate blocking the program or programs that the user desires to be blocked.

The content control mechanism 114 may also be utilized to unblock content. For example, in one embodiment, the device 100 may be configured such that pressing a parental control button initiates gathering of characteristics (e.g., rating information) associated with the content currently being blocked and use of the characteristics to remove such blocking criteria from the blocking configuration. During such a process, the user may be provided with a series of queries that may be easily answered by making selections with the controller 112. These queries may be directed to confirming that the user understands the choices being made regarding unblocking certain content. Further, some queries may determine the scope of the user's decision to unblock content.

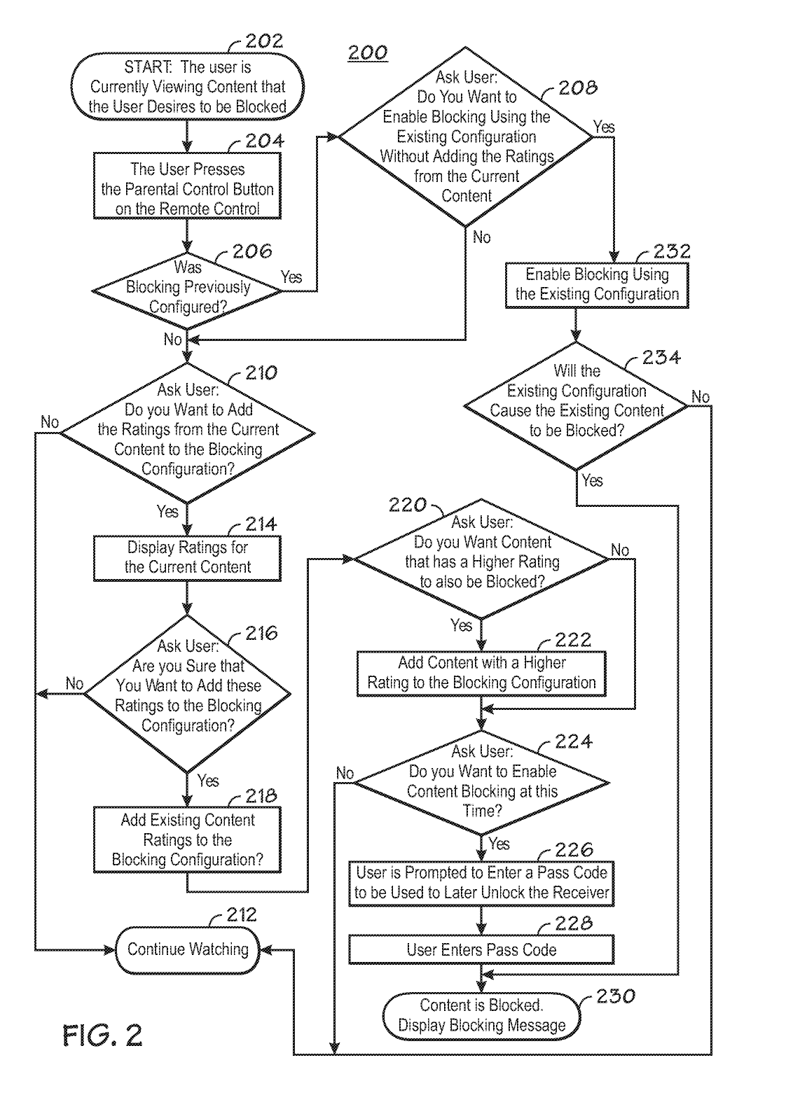

FIG. 2 is a block diagram representing a process in accordance with one embodiment of the present invention. The process is generally indicated by reference numeral 200 and begins with block 202. Specifically, block 202 represents that a user is watching content that the user wishes to block. To initiate blocking of the current content, a content control mechanism 114 or a similar mechanism may be activated. Indeed, as illustrated by block 204, the user may activate (e.g., depress) a parental control button, which initiates a series of user queries and determinations regarding configuration status, as will be discussed in detail below.

Upon activation of the parental control button in block 204, the process 200 determines whether blocking was previously configured, as illustrated by block 206. That is, block 206 represents a determination as to whether or not the electronic device 100 has previously been configured to block any content. If a configuration for content blocking has already been established, the process 200 proceeds to block 208 to determine whether the user merely intended to activate the previously established configuration or to add the current content to that configuration. If no content blocking criteria were previously configured, the process continues to block 210. The procedures associated with each of these scenarios will be discussed in detail below.

If a determination is made in block 206 that no content blocking configuration has been established, the user is queried in block 210 to determine whether the user wants to add characteristics, such as ratings, from the current content (e.g., a television program being watched) as blocking configuration criteria. This acts as an initial confirmation of the user's desire to block the programming. For example, the user may have accidentally activated the parental control button, and if the user responds to the query of block 210 by indicating that the content should not be blocked, the process may proceed to block 212. Block 212 represents continued display of the content. However, if the user confirms that the content should be blocked, the ratings of the current content may be displayed on the electronic device 100, as illustrated by block 214 and the user may be prompted to confirm that the ratings of the current content should be added to the blocking configuration, as represented by block 216. If the user responds to the query of block 216 by indicating that the ratings should not be added to the blocking configuration, the process may proceed to block 212. However, if the user confirms that the content should be blocked, the process 100 continues to block 218, which represents adding the ratings of the current content to a new blocking configuration or an existing blocking configuration when the existing blocking configuration is available.

Once the ratings of the current content are added to the blocking configuration in block 218, the user is queried as to whether content having a higher or stricter rating than that of the current content should also be blocked. Such a query is represented by block 220. If the user indicates that content with higher ratings should be blocked, ratings higher than that of the current content are added to the blocking configuration, as illustrated by block 222. If the user does not confirm that ratings higher than that of the current content should be blocked, the process 200 proceeds directly to block 224 and skips block 222.

Block 224 represents querying the user regarding whether content blocking should be enable immediately. If the user responds by confirming that the content should be blocked immediately, the user is prompted to enter a pass code, as illustrated by block 226. The pass code can later be used to unlock the tuner 104 to allow editing of the blocking configuration. Once the pass code is entered, as illustrated by block 228, the content is blocked and a blocking message (e.g., “This program is currently blocked and unavailable.”) may be displayed on the electronic device 100 (e.g., via the display 110) when a user attempts to access content blocked by the blocking configuration, such as content with a rating that is too high. Blocking the content and displaying the blocking message are represented by block 230.

In reference back to block 206, if a determination is made that a blocking configuration is already in existence, the process 200 proceeds to block 208. Block 208 represents querying the user to determine whether the user activated the parental control button to enable blocking using the existing blocking configuration. If the user indicates that the existing blocking configuration should be modified, the process 200 continues to block 210 and proceeds as discussed above. In other words, if the user indicates that he or she did not merely intend to enable an existing blocking configuration, the process 200 proceeds to block 210. In contrast, if the user indicates that an existing configuration is to be utilized, the process 200 continues to block 232, which represents enabling blocking using the existing blocking configuration. In some embodiments, the process 200 may simply confirm that the blocking configuration was already enabled and proceed to block 212.

Once the existing blocking configuration is enabled, a determination is made as to whether the existing blocking configuration will cause the current content to be blocked. This determination is represented by block 234. If the current content is not blocked by the existing blocking configuration, the process 200 proceeds to block 212 and the content continues to be displayed. If the existing blocking configuration is configured to block the current content, the process 200 proceeds to block 230, which represent the content being blocked and a blocking message being displayed.

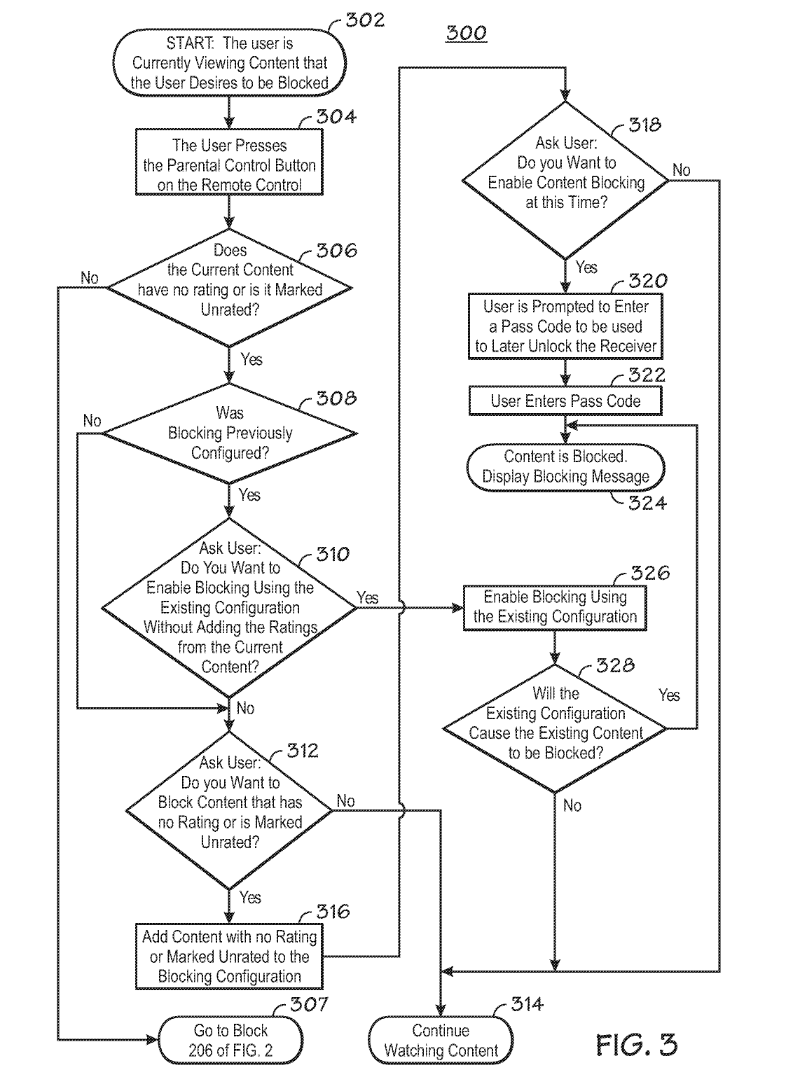

FIG. 3 is a block diagram representing a process in accordance with one embodiment of the present invention. The process is generally indicated by reference numeral 300 and begins with block 302. Specifically, block 302 represents that a user is watching content that the user wishes to block. To initiate blocking of the current content, the content control mechanism 114 or a similar mechanism may be activated. Indeed, as illustrated by block 304, the user may activate (e.g., depress) a parental control button 114, which initiates a series of user queries and determinations regarding configuration status, as will be discussed in detail below.

Upon activation of the parental control button in block 304, the process 300 determines whether the content has no rating or is explicitly unrated, as illustrated by block 306. In other words, block 306 represents determining whether a program has a rating (e.g., TV-Y through TV-MA) or does not have a rating (e.g., the rating is absent or the program is explicitly designated as unrated). If the program does have a rating, the process 300 may continue as set forth with respect to the process 200 illustrated in FIG. 2. More specifically, the process 300 may continue to block 206 of the process 200. In contrast, if the program does not have a rating, the process 300 continues to block 308, which represents a determination as to whether blocking was previously configured. That is, block 308 represents a determination as to whether or not the electronic device 100 has previously been configured to block any content. If a configuration for content blocking has already been established, the process 300 proceeds to block 310 to determine whether the user merely intended to activate the previously established configuration or to add the current content to a blocking configuration. If no content blocking criteria have been previously configured, the process proceeds from block 308 to block 312.

If a determination is made in block 308 that no content blocking configuration has been established or a determination is made in block 310 that the users does not simply desire to activate an existing configuration, the user is queried in block 312 to determine whether the user wants to establish blocking criteria to prevent access to programs that have no rating or that are marked as unrated. If the user responds to the query of block 312 by indicating that the content should not be blocked, the activation of the parental control button will essentially be treated as inadvertent and the process proceeds to block 314, which represents continued display of the content. However, if the user confirms that the content should be blocked, the process 300 continues to block 316, which represents adding content that has no rating or is marked as unrated to a new blocking configuration or an existing blocking configuration when available. In some exemplary embodiments, separate procedures may be performed depending on whether the content is explicitly unrated or simply does not have a rating.

Once programming that has no rating or that is explicitly unrated is added to the blocking configuration in block 316, the user is queried as to whether content blocking should be enable immediately, as represented by block 318. If the user indicates that blocking should not be immediately initiated, the process 300 continues to block 314, which represents continued presentation of the content. If the user responds by confirming that the content should be blocked immediately, the user is prompted to enter a pass code that can later be used to unlock the tuner 104, as illustrated by block 320. Once the pass code is entered, as illustrated by block 322, the content is blocked and a blocking message may be displayed on the electronic device 100 when a user attempts to access content blocked by the blocking configuration, such as content that is not rated or that is designated as unrated. Blocking the content and displaying the blocking message is represented by block 324.

In reference back to block 308, if a determination is made that a blocking configuration is already in existence, the process 300 proceeds to block 310. Block 310 represents querying the user to determine whether the user activated the parental control button to enable blocking using the existing blocking configuration or to modify blocking criteria. If the user indicates that the existing blocking configuration should be modified, the process 300 continues to block 312 and proceeds as discussed above. In other words, if the user indicates that he or she did not merely intend to enable an existing blocking configuration, the process 300 proceeds to block 312. In contrast, if the user indicates that an existing configuration is to be utilized, the process 300 continues to block 326, which represents enabling blocking using the existing blocking configuration. It should be noted that the process 300 may simply confirm that the blocking configuration was already enabled and proceed to block 314 because the content was clearly not blocked by the existing blocking configuration.

Once the existing blocking configuration is enabled, a determination is made as to whether the existing blocking configuration will cause the current content to be blocked. This determination is represented by block 328. If the current content is not blocked by the 10 existing blocking configuration, the process 300 proceeds to block 314 and the content continues to be displayed. If the existing blocking configuration is configured to block the current content, the process 300 proceeds to block 324, the content is blocked, and a blocking message is displayed.

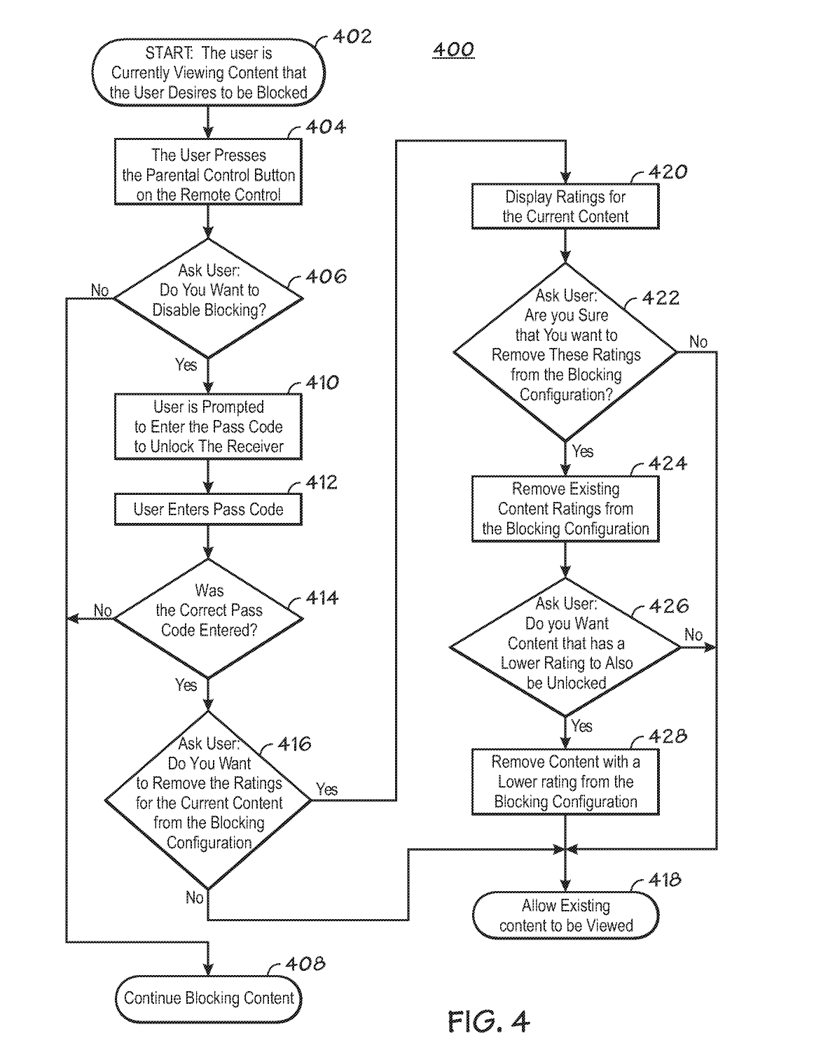

FIG. 4 is a block diagram representing a process in accordance with one embodiment of the present invention. The process is generally indicated by reference numeral 400 and begins with block 402. Specifically, block 402 represents that a user is watching content that the user wishes to view but that is presently blocked. To initiate unblocking of the current content, the content control mechanism 114 or a similar mechanism may be activated. Indeed, as illustrated by block 404, the user may activate (e.g., depress) a parental control button, which initiates a series of user queries and determinations regarding configuration status, as will be discussed in detail below.

Once the parental control button has been activated in block 404, the process 400 queries the user to confirm that the user activated the parental control button to disable blocking, as illustrated by block 406. If the user indicates that activation of the parental control button was not intended to unblock the content, the activation is essentially treated as unintentional, the process 400 continues to block 408 and the content continues to be blocked. However, if the user indicates that the intent was to unblock the content, the user is prompted to enter the pass code that unlocks the receiver, as represented by block 410. Block 412 represents entering the pass code and block 414 represents determining whether the entered pass code is correct.

If the entered pass code is incorrect, the process 400 continues to block 408 and the program remains blocked. Alternatively, if the entered pass code is correct, the user is asked whether the ratings from the current program should be removed from the blocking configuration, as represented by block 416. If the user indicates that the ratings for the current program should not be removed from the blocking configuration, the process 400 proceeds to block 418 and the current content is made available. By indicating that the ratings for the current program should not be removed from the blocking configuration, the user confirms that the current program should be accessible and that other programs with the same ratings that are currently blocked should remain blocked. In some embodiments, such unblocking of an individual program may be temporary. In other embodiments, the individual program may be established as an exception in the blocking configuration. If the user indicates that the ratings for the current program should be removed from the blocking configuration, the user is essentially indicating that all programs with the same rating as that of the current program should be made accessible and the process continues to block 420. Block 420 represents displaying characteristics of the current program to the user.

The display represented by block 420 is followed by querying the user to confirm that the user wants to remove the ratings from being blocked by the blocking confirmation, as represented by block 422. If the user indicates that the ratings should not be removed from the blocking configuration, the process proceeds to block 418. In some embodiments, the process 400 may proceed to block 408 when the user indicates that the ratings should not be removed. If the user indicates that he or she is sure that the ratings should be removed from the blocking configuration, the ratings are removed from the blocking configuration, as represented by block 424.

After the ratings are removed from the blocking configuration, as represented by block 424, the process continues to block 426. Block 426 represents a query to determine whether the user wishes to unblock content that has a lower rating than that of the current program. If the user indicates that content with a lower rating should not be unblocked, the process 400 continues to block 418. In contrast, if the user indicates that content with a lower rating should be unblocked, the process 400 continues to block 428, which represents removing lower ratings from the blocking configuration. After the blocking configuration is reconfigured in block 428, the process 400 proceeds to block 418.

It should be noted that present embodiments may cooperate with existing V-Chip technology. For example, present embodiments may facilitate user configuration of a V-Chip for content blocking without requiring the user to understand the rating system or the user interface of the V-Chip. Further, present embodiments may include blocking and unblocking options that are not available for the existing V-Chip technology. For example, in some embodiments, the tuner 104 may maintain a statistical history of the content ratings present each time the users activates the content control mechanism 114. The tuner 104 may be configured to make intelligent decisions to block or unblock content that has not been explicitly blocked but that has a similar rating to the ratings blocked throughout the statistical history. Other examples of blocking and unblocking options may include blocking content with certain characteristics, such as a specific program title, specific metadata tags, and certain keywords in an extended description. These types of content may be blocked or unblocked by manipulating the blocking configuration to add or remove the related information (e.g., title, metadata tags, or keywords). The program titles, metadata tags, and program descriptions may be accessible from an external program guide, in-band in the content itself, or from other such sources.

While the present techniques may be susceptible to various modifications and alternative forms, specific embodiments have been shown by way of example in the drawings and are described in detail herein. However, it should be understood that the techniques are not intended to be limited to the particular forms disclosed. For example, with regard to the processes discussed above, the user queries may be optional and may be asked or omitted depending on design. Further, certain aspects of the disclosed processes may be performed in an order different than that illustrated. It should be noted that the disclosed techniques are to cover all modifications, equivalents and alternatives falling within the spirit and scope of the techniques as defined by the following appended claims.

What is claimed is:

1. A method (300), comprising:
initiating (302) a content blocking procedure based on activation of a content control mechanism;
determining (306) at least one characteristic of content being provided at the time the content control mechanism was activated; and
defining (326) a blocking configuration to block the content being provided at the time the content control mechanism was activated based on the at least one characteristic of the content.

2. The method (300) of claim 1, wherein determining (306) the at least one characteristic of the content comprises determining a rating.

3. The method (300) of claim 1, wherein determining (306) the at least one characteristic of the content comprises determining a title, a metadata tag or keyword associated with the content.

4. The method (300) of claim 1, comprising determining whether the blocking configuration was previously configured and providing a query regarding whether the blocking configuration should be activated when a determination is made that the blocking configuration was previously configured and is not presently activated.

5. The method (300) of claim 1, comprising determining whether the blocking configuration was previously configured and providing a query regarding whether the characteristics should be added to the blocking configuration when a determination is made that the blocking configuration was not previously configured.

6. The method (300) of claim 1, comprising adding the at least one characteristic to the blocking configuration to block all content having the at least one characteristic.

7. The method (300) of claim 6, wherein determining the at least one characteristic of the content comprises determining that the content has no rating or determining that the content is explicitly unrated.

8. The method (300) of claim 1, comprising providing a query to determine whether a user desires characteristics within a fixed relationship to the at least one characteristic to be blocked.

9. The method (300) of claim 1, comprising providing a query to determine whether a user desires ratings stricter than a rating of the content to be blocked, wherein the at least one characteristic is the rating.

10. A method (400), comprising:
initiating (402) a content unblocking procedure based on activation of a content control mechanism while content is being prevented from presentation on an electronic device;
prompting (406) a user to input a pass code;
comparing (414) an entered pass code with a valid pass code; and
unblocking (424) the content when the entered pass code matches the valid pass code.

11. The method (400) of claim 10, comprising determining a characteristic of the content.

12. The method (400) of claim 11, comprising providing a query regarding whether all content with the same characteristic should be unblocked.

13. The method (400) of claim 12, comprising unblocking all content with the same characteristic when the user indicates that all content with the same characteristic should be unblocked.

14. The method (400) of claim 10, comprising unblocking all content with the same characteristic.

15. The method (400) of claim 11, comprising unblocking all content having characteristics within a fixed relationship to the characteristic.

16. A system (100), comprising:
a memory (108);
a display (110); and
a controller (112) that is adapted to manipulate a blocking configuration stored in the memory (108) based on current content being presented on the display (110) when a content control mechanism is activated, wherein the blocking configuration controls what types of content may be provided via the display (110).

17. The system (100) of claim 16, wherein the content control mechanism is a button.

18. The system (100) of claim 16, wherein the controller comprises a V-Chip media management device.

19. The system (100) of claim 16, wherein access to manipulation of the blocking configuration is limited to access via the content control mechanism.

20. The system (100) of claim 16, wherein the controller is configured to block all content having a stricter rating than a rating of the current content.
